(19) United States
(12) Patent Application Publication
(10) Pub. No.: US 2020/0243237 A1
(43) Pub. Date: Jul. 30, 2020

(54) SOFT MAGNETIC POWDER, POWDER MAGNETIC CORE, MAGNETIC ELEMENT, AND ELECTRONIC DEVICE

(71) Applicant: SEIKO EPSON CORPORATION, Tokyo (JP)

(72) Inventor: Yasuko KUDO, Hachinohe-shi (JP)

(73) Assignee: SEIKO EPSON CORPORATION, Tokyo (JP)

(21) Appl. No.: 16/775,318

(22) Filed: Jan. 29, 2020

(30) Foreign Application Priority Data
Jan. 30, 2019 (JP) 2019-014648

(51) Int. Cl. H01F 1/153; H01F 1/20; H01F 1/147

(52) U.S. Cl. CPC H01F 1/153; H01F 1/14766; H01F 1/20

(57) ABSTRACT

A soft magnetic powder has a composition represented by FeₓCuₐ(Nb_{1-z}Zn_{z})_{b}(Si_{1-y}B_{y})_{100-x-a-b} [provided that a, b, and x are each a number whose unit is at %, and are numbers satisfying 0.3≤a≤2.0, 2.0≤b≤4.0, and 73.0≤x≤79.5, and y is a number satisfying f(x)≤y<0.99, in which f(x)=(4×10⁻³⁴)x^{17.56}, and z is a number satisfying 0<z≤1.0], and contains a crystalline structure having a particle diameter of 1.0 nm or more and 30.0 nm or less at 30 vol % or more.

The present application is based on, and claims priority from JP Application Serial Number 2019-014648, filed on Jan. 30, 2019, the disclosure of which is hereby incorporated by reference herein in its entirety.

### BACKGROUND

### 1. Technical Field

The present disclosure relates to a soft magnetic powder, a powder magnetic core, a magnetic element, and an electronic device.

### 2. Related Art

Recently, a reduction in the size and weight of mobile devices such as notebook-type personal computers have advanced. However, in order to achieve both reduction in the size and enhancement of the performance at the same time, it is necessary to increase the frequency of a switched-mode power supply. Accompanying this, also a magnetic element such as a choke coil or an inductor incorporated in a mobile device needs to cope with the increase in the frequency.

For example, JP-A-2009-263775 (Patent Document 1) discloses an amorphous alloy thin strip that is represented by Fe_{(100-a-b-c-d)}MₐSi_{b}B_{c}Cu_{d} (at %) in which 0≤a≤10, 0≤b≤20, 4≤c≤20, 0.1≤d≤3, and 9≤a+b+c≤35, and contains unavoidable impurities, wherein M is at least one element selected from Ti, V, Zr, Nb, Mo, Hf, Ta, and W, a Cu-segregated portion is present, and the maximum Cu concentration in the Cu-segregated portion is 4 at % or less.

It is also disclosed that such an amorphous alloy thin strip can also be applied to a powder magnetic core by being powdered.

However, the powder magnetic core described in Patent Document 1 has a problem that the iron loss at a high frequency is large. Therefore, in order to cope with an increase in the frequency, a reduction in the iron loss of the magnetic element, that is, the soft magnetic powder has been required.

On the other hand, in mobile devices such as smartphones, an increase in the electric current in circuits and a reduction in the size of circuits have advanced. In order to cope with such an increase in the electric current and a reduction in the size, it is necessary to increase the magnetic flux density of the soft magnetic powder, however, currently, a sufficient increase in the magnetic flux density has not been achieved.

### SUMMARY

The present disclosure can be implemented as the following application example.

A soft magnetic powder according to this application example has a composition represented by FeₓCuₐ(Nb_{1-z}Zn_{z})_{b}(Si_{1-y}B_{y})_{100-x-a-b} [provided that a, b, and x are each a number whose unit is at %, and are numbers satisfying 0.3≤a≤2.0, 2.0≤b≤4.0, and 73.0≤x≤79.5, and y is a number satisfying f(x)≤y<0.99, in which f(x)=(4×10³⁴)x^{17.56}, and z is a number satisfying 0<z≤1.0], and contains a crystalline structure having a particle diameter of 1.0 nm or more and 30.0 nm or less at 30 vol % or more.

### BRIEF DESCRIPTION OF THE DRAWINGS

FIG. 1 is a view showing a region in which a range of x and a range of y overlap with each other in a two-axis orthogonal coordinate system in which x is represented by the horizontal axis and y is represented by the vertical axis.

FIG. 2 is a plan view schematically showing a choke coil to which a first embodiment of a magnetic element is applied.

FIG. 3 is a transparent perspective view schematically showing a choke coil, to which a second embodiment of a magnetic element is applied.

FIG. 4 is a longitudinal cross-sectional view showing one example of a device for producing a soft magnetic powder by a spinning water atomization method.

FIG. 5 is a perspective view showing a configuration of a mobile-type personal computer, to which an electronic device including a magnetic element according to an embodiment is applied.

FIG. 6 is a plan view showing a configuration of a smartphone, to which an electronic device including a magnetic element according to an embodiment is applied.

FIG. 7 is a perspective view showing a configuration of a digital still camera, to which an electronic device including a magnetic element according to an embodiment is applied.

FIG. 8 is a view in which points corresponding to x and y of alloy compositions of soft magnetic powders obtained in respective Examples and respective Comparative Examples are plotted in the orthogonal coordinate system shown in FIG. 1.

### DESCRIPTION OF EXEMPLARY EMBODIMENTS

Hereinafter, a soft magnetic powder, a powder magnetic core, a magnetic element, and an electronic device according to the present disclosure will be described in detail based on preferred embodiments shown in the accompanying drawings.

### Soft Magnetic Powder

The soft magnetic powder according to an embodiment is a metal powder having soft magnetism. Such a soft magnetic powder can be applied to any purpose utilizing soft magnetism, and is used for, for example, producing a powder magnetic core by binding the particles to one another through a binding material and also molding the powder into a given shape.

The soft magnetic powder according to the embodiment is a powder having a composition represented by FeₓCuₐ(Nb_{1-z}Zn_{z})_{b}(Si_{1-y}B_{y})_{100-x-a-b}. Here, a, b, and x each represent a number whose unit is at % and are numbers satisfying 0.3≤a≤2.0, 2.0≤b≤4.0, and 73.0≤x≤79.5. Further, y is a number satisfying f(x)≤y<0.99, in which f(x)=(4×10⁻³⁴)x^{17.56}. Further, z is a number satisfying 0<z≤1.0.

Further, the soft magnetic powder according to the embodiment contains a crystalline structure having a crystalline particle diameter of 1.0 nm or more and 30.0 nm or less at 30 vol % or more.

Such a soft magnetic powder enables the production of a powder magnetic core (green compact) having small iron loss and a large magnetic flux density. Such a powder magnetic core contributes to the realization of a magnetic element that can cope with a large electric current and has high efficiency.

Hereinafter, the composition of the soft magnetic powder according to the embodiment will be described in detail.

Fe (iron) has a large effect on the basic magnetic properties and mechanical properties of the soft magnetic powder according to the embodiment.

The content x of Fe is set to 73.0 at % or more and 79.5 at % or less, but is preferably set to 76.0 at % or more and 79.0 at % or less, more preferably set to 76.5 at % or more and 79.0 at % or less. When the content x of Fe is less than the above lower limit, the magnetic flux density of the soft magnetic powder may be decreased. On the other hand, when the content x of Fe exceeds the above upper limit, the amorphous structure cannot be stably formed when producing the soft magnetic powder, and therefore, it may become difficult to form the crystalline structure having a small particle diameter as described above.

Cu (copper) tends to be separated from Fe when producing the soft magnetic powder according to the embodiment from a raw material, and therefore causes a fluctuation in the composition, and thus, a region that is easily crystallized is partially formed. As a result, deposition of an Fe phase with a body-centered cubic lattice that is relatively easily crystallized is promoted, and thus, the formation of the crystalline structure having a small particle diameter as described above can be facilitated.

The content a of Cu is set to 0.3 at % or more and 2.0 at % or less, but is preferably set to 0.5 at % or more and 1.5 at % or less. When the content a of Cu is less than the above lower limit, the micronization of the crystalline structure is impaired, and therefore, the crystalline structure having a particle diameter within the above range may not be able to be formed. On the other hand, when the content a of Cu exceeds the above upper limit, the mechanical properties of the soft magnetic powder are deteriorated, and embrittlement may be caused.

Nb (niobium) is added as needed and contributes to the micronization of the crystalline structure along with Cu when subjecting a powder containing an amorphous structure in a large amount to a heat treatment. Therefore, the formation of the crystalline structure having a small particle diameter as described above can be facilitated.

Zn (zinc) is an element that has a low melting point and strongly binds to Cu. Therefore, when the soft magnetic powder according to the embodiment is produced from a raw material, segregation of Cu in an amorphous state can be suppressed. Accordingly, generation of coarse crystalline particles is suppressed by subjecting a powder containing such an amorphous structure to a heat treatment. As a result, a soft magnetic powder having favorable soft magnetism, that is, a low coercive force and small iron loss, and a high magnetic permeability is obtained.

Further, by suppressing generation of coarse crystalline particles, a crystalline structure having a uniform particle diameter is formed in the soft magnetic powder. According to this, for example, even when the content x of Fe is set relatively high as in the above range, effective magnetic anisotropy is decreased. As a result, deterioration of soft magnetism can be suppressed while increasing the magnetic flux density of the soft magnetic powder. Accordingly, a soft magnetic powder capable of producing a powder magnetic core having small iron loss and a high magnetic flux density is obtained.

The sum b of the content of Nb and the content of Zn is set to 2.0 at % or more and 4.0 at % or less, but is preferably set to 2.5 at % or more and 3.5 at % or less. When the sum b of the content of Nb and the content of Zn is less than the above lower limit, the micronization of the crystalline structure is impaired, and therefore, the crystalline structure having a particle diameter within the above range may not be able to be formed. On the other hand, when the sum b exceeds the above upper limit, the mechanical properties of the soft magnetic powder are deteriorated, and embrittlement may be caused. Further, the magnetic permeability of the soft magnetic powder may be decreased.

Here, when the sum b of the content of Nb and the content of Zn is assumed to be 1 and the ratio of the content of Zn to this sum b is represented by z, the ratio of the content of Nb to the sum b is represented by (1-z).

This z is a number satisfying 0<z≤1.0, preferably a number satisfying 0.33≤z≤1.0, more preferably a number satisfying 0.50<z<1.0. According to this, a soft magnetic powder capable of producing a powder magnetic core having small iron loss and a high magnetic flux density is obtained. Further, in particular, by using Nb and Zn in combination, the above-mentioned effect brought about by Nb and the above-mentioned effect brought about by Zn can be achieved at the same time, so that a soft magnetic powder in which a crystalline structure having a small and uniform particle diameter is formed can be realized. As a result, a soft magnetic powder achieving particularly favorable soft magnetism and a particularly high magnetic flux density at the same time can be realized.

Si (silicon) promotes amorphization when producing the soft magnetic powder according to the embodiment from a raw material. Therefore, when producing the soft magnetic powder according to the embodiment, first, a homogeneous amorphous structure is formed, and thereafter, the amorphous structure is crystallized, whereby the formation of a crystalline structure having a more uniform particle diameter is facilitated. Then, the uniform particle diameter contributes to the averaging out of magnetocrystalline anisotropy in each crystalline particle, and therefore, the coercive force can be decreased and also the magnetic permeability can be increased, and thus, the improvement of soft magnetism can be achieved.

B (boron) promotes amorphization when producing the soft magnetic powder according to the embodiment from a raw material. Therefore, when producing the soft magnetic powder according to the embodiment, first, a homogeneous amorphous structure is formed, and thereafter, the amorphous structure is crystallized, whereby the formation of a crystalline structure having a more uniform particle diameter is facilitated. Then, the uniform particle diameter contributes to the averaging out of magnetocrystalline anisotropy in each crystalline particle, and therefore, the coercive force can be decreased and also the magnetic permeability can be increased, and thus, the improvement of soft magnetism can be achieved. Further, by using Si and B in combination, based on the difference in atomic radius between Si and B, it is possible to synergistically promote amorphization.

Here, when the sum of the content of Si and the content of B is assumed to be 1 and the ratio of the content of B to this sum is represented by y, the ratio of the content of Si to this sum is represented by (1-y).

This y is a number satisfying f(x)≤y<0.99, and f(x) that is a function of x satisfies f(x)=(4×10⁻³⁴)x^{17.56}.

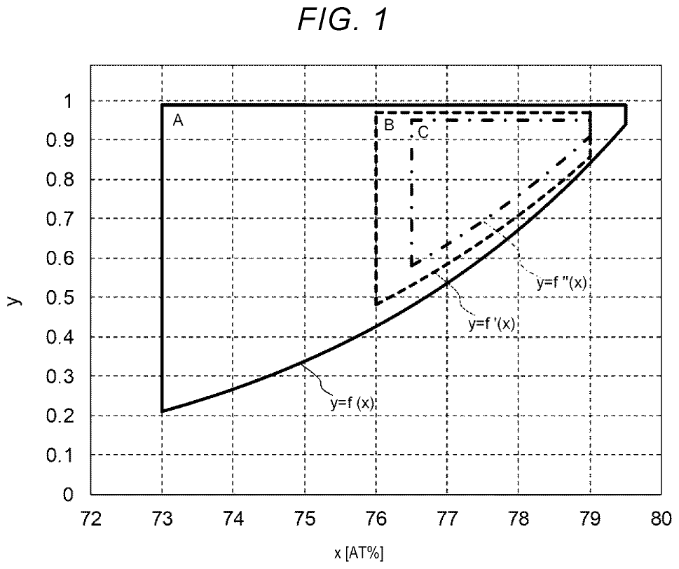

FIG. 1 is a view showing a region in which the range of x and the range of y overlap with each other in a two-axis orthogonal coordinate system in which x is represented by the horizontal axis and y is represented by the vertical axis.

In FIG. 1, a region A in which the range of x and the range of y overlap with each other is located inside a solid line drawn in the orthogonal coordinate system. Therefore, an (x, y) coordinate located in the region A corresponds to x and y included in the composition formula representing the composition of the soft magnetic powder according to the embodiment.

The region A corresponds to a closed region surrounded by three straight lines and one curved line formed when plotting each of the (x, y) coordinates satisfying the following four equations: x=73.0, x=79.5, y=f(x), and y=0.99 in the orthogonal coordinate system.

Further, y is preferably a number satisfying f′(x)≤y≤0.97, and f′(x) that is a function of x satisfies f′(x)=(4×10⁻²⁹)x^{14.93}.

A broken line shown in FIG. 1 shows a region B in which the range of preferred x described above and the range of preferred y described above overlap with each other. The (x, y) coordinate located in the region B corresponds to preferred x and preferred y included in the composition formula representing the composition of the soft magnetic powder according to the embodiment.

The region B corresponds to a closed region surrounded by three straight lines and one curved line formed when plotting each of the (x, y) coordinates satisfying the following four equations: x=76.0, x=79.0, y=f′(x), and y=0.97 in the orthogonal coordinate system.

Further, y is more preferably a number satisfying f□(x)≤y≤0.95, and f□(x) that is a function of x satisfies f␣(x)=(4×10²⁹)x^{14.93}+0.05.

An alternate long and short dash line shown in FIG. 1 shows a region C in which the range of more preferred x described above and the range of more preferred y described above overlap with each other. The (x, y) coordinate located in the region C corresponds to more preferred x and more preferred y included in the composition formula representing the composition of the soft magnetic powder according to the embodiment.

The region C corresponds to a closed region surrounded by three straight lines and one curved line formed when plotting each of the (x, y) coordinates satisfying the following four equations: x=76.5, x=79.0, y=f␣(x), and y=0.95 in the orthogonal coordinate system.

When x and y are included at least in the region A, the soft magnetic powder can suppress the iron loss of a green compact to be produced small. That is, in such a soft magnetic powder, when producing it, a homogeneous amorphous structure can be formed with a high probability, and therefore, by crystallizing the amorphous structure, a crystal structure having a particularly uniform particle diameter can be formed. Accordingly, the coercive force can be sufficiently decreased, and the iron loss of the green compact can be suppressed sufficiently small.

Further, when x and y are included at least in the region A, the soft magnetic powder can increase the magnetic flux density of a green compact to be produced. That is, in such a soft magnetic powder, by the addition of Zn (zinc), a crystalline structure having a small particle diameter can be formed, and low iron loss can be achieved even when the content of Fe (iron) is increased to some extent. According to this, a green compact having a high magnetic flux density can be realized while sufficiently decreasing the iron loss.

In a case where the value of y is deviated to the side smaller than the region A, it becomes difficult to form a homogeneous amorphous structure when producing the soft magnetic powder. Therefore, a crystalline structure having a small particle diameter cannot be formed, and the coercive force cannot be sufficiently decreased.

On the other hand, also in a case where the value of y is deviated to the side larger than the region A, it becomes difficult to form a homogeneous amorphous structure when producing the soft magnetic powder. Therefore, a crystalline structure having a small particle diameter cannot be formed, and the coercive force cannot be sufficiently decreased.

The lower limit of y is determined by the function of x as described above, but is set to preferably 0.30 or more, more preferably 0.35 or more, further more preferably 0.40 or more. According to this, a decrease in the coercive force of the soft magnetic powder and an increase in the magnetic permeability and a decrease in the iron loss of the green compact can be achieved.

In particular, the regions B and C are regions in which the value of x is relatively large in the region A, and therefore, the content of Fe becomes high. Due to this, the magnetic flux density of the soft magnetic powder can be increased. Therefore, the magnetic flux density is high so that a decrease in the size and an increase in the efficiency of a powder magnetic core or a magnetic element can be achieved.

(100-x-a-b) that is the sum of the content of Si and the content of B is not particularly limited, but is preferably 15.0 at % or more and 24.0 at % or less, more preferably 16.0 at % or more and 22.0 at % or less. When (100-x-a-b) is within the above range, a crystalline structure having a particularly uniform particle diameter can be formed in the soft magnetic powder.

C (carbon) is a metalloid element that is added as needed and enables amorphization even if the content of Fe is high when producing the soft magnetic powder according to the embodiment from a raw material. Therefore, in the soft magnetic powder according to the embodiment, the magnetic flux density is increased, and also the formation of a crystalline structure having a more uniform and smaller particle diameter is facilitated. Then, the uniform particle diameter contributes to the averaging out of magnetocrystalline anisotropy in each crystalline particle, and therefore, the coercive force can be decreased and also the magnetic permeability can be increased, and thus, the improvement of soft magnetism can be achieved.

The content of C is set to preferably 0.1 at % or more and 4.0 at % or less, more preferably 0.3 at % or more and 3.0 at % or less, further more preferably 0.5 at % or more and 2.0 at % or less. According to this, a soft magnetic powder capable of producing a powder magnetic core having small iron loss and a particularly high magnetic flux density is obtained. If the content of C is less than the above lower limit, when the content of Fe is high, that is, when the content of Fe is within the above range, the uniformity of the particle diameter of the crystalline structure may be impaired, and the crystalline structure having a particle diameter within the above range may not be able to be formed. On the other hand, if the content of C exceeds the above upper limit, when the content of Fe is high, amorphization may become difficult and also the magnetic properties including magnetic flux density of the soft magnetic powder may be deteriorated.

When C (carbon) is contained and the content of C is represented by c at %, (100-x-a-b-c) corresponds to the sum of the content of Si and the content of B, and y(100-x-a-b-c) corresponds to the content of B in the soft magnetic powder. The y(100-x-a-b-c) is appropriately set in consideration of the coercive force, magnetic permeability, iron loss, or the like as described above, however, the composition of the soft magnetic powder preferably satisfies 9.2≤y(100-x-a-b-c)≤16.2, more preferably satisfies 9.5≤y(100-x-a-b-c)≤15.0.

According to this, a soft magnetic powder containing B (boron) at a relatively high concentration is obtained. Such a soft magnetic powder enables the formation of a homogeneous amorphous structure in the production thereof even when the content of Fe is high and also C (carbon) is contained. Therefore, by a heat treatment thereafter, a crystalline structure having a small particle diameter and also having a relatively uniform particle diameter can be formed, and a high magnetic flux density can be achieved while sufficiently decreasing the coercive force.

If y(100-x-a-b-c) is less than the above lower limit, the content of B becomes small, and therefore, when producing the soft magnetic powder, amorphization in a case of containing C may become difficult depending on the composition as a whole. On the other hand, if y(100-x-a-b-c) exceeds the above upper limit, the content of B becomes large and the content of Si is relatively decreased, and therefore, the magnetic permeability of the soft magnetic powder may be decreased.

Further, C/B that is the ratio of the content of C (carbon) to the content of B (boron) is not particularly limited, but is preferably 0.030 or more and 0.170 or less in atomic number ratio, more preferably 0.030 or more and 0.120 or less in atomic number ratio, and further more preferably 0.050 or more and 0.107 or less in atomic number ratio. By setting C/B within the above range, the effect of promoting amorphization when producing the soft magnetic powder even in a case where the content of Fe is high can be further enhanced. That is, by optimizing the ratio of the content of C to the content of B, a crystalline structure having a more uniform and smaller particle diameter can be formed in the composition having a high content of Fe.

When C/B is less than the above lower limit or exceeds the above upper limit, the synergistic effect of C and B as described above may not be obtained.

The soft magnetic powder according to the embodiment may contain impurities other than the composition represented by FeₓCuₐ(Nb_{1-z}Zn_{z})_{b}(Si_{1-y}B_{y})_{100-x-a-b} described above or elements to be arbitrarily added such as C. Examples of the impurities include all elements other than the above-mentioned elements, however, the total content of the impurities is preferably 0.50 at % or less. When the total content thereof is within this range, the impurities hardly inhibit the effects of the present disclosure, and therefore, the incorporation thereof is permitted.

Further, the content of each of the impurity elements is preferably 0.05 at % or less. When the content thereof is within this range, the impurities hardly inhibit the effects of the present disclosure, and therefore, the incorporation thereof is permitted.

Among these, the content of Al (aluminum) is particularly preferably 0.03 at % or less, more preferably 0.02 at % or less. By suppressing the content of Al within the above range, the particle diameter of the crystalline structure to be formed in the soft magnetic powder can be prevented from becoming nonuniform. Therefore, the deterioration of the magnetic properties such as magnetic permeability can be suppressed.

The content of Ti (titanium) is particularly preferably 0.02 at % or less, more preferably 0.01 at % or less. By suppressing the content of Ti within the above range, the particle diameter of the crystalline structure to be formed in the soft magnetic powder can be prevented from becoming nonuniform. Therefore, the deterioration of the magnetic properties such as magnetic permeability can be suppressed.

Note that (100-x-a-b) that is the sum of the content of Si and the content of B is uniquely determined according to the values of x, a, and b, however, a deviation of ±0.50 at % or less by taking (100-x-a-b) as a central value due to the production error or the effect of impurities is permitted.

Further, when C is added, (100-x-a-b-c) that is the sum of the content of Si and the content of B is uniquely determined according to the values of x, a, b, and c, however, a deviation of ±0.50 at % or less by taking (100-x-a-b-c) as a central value due to the production error or the effect of impurities is permitted.

Hereinabove, the composition of the soft magnetic powder according to the embodiment has been described in detail, however, the composition and impurities are determined by an analytical method as described below.

Examples of such an analytical method include Iron and steel—Atomic absorption spectrometric method specified in JIS G 1257: 2000, Iron and steel—ICP atomic emission spectrometric method specified in JIS G 1258: 2007, Iron and steel—Method for spark discharge atomic emission spectrometric analysis specified in JIS G 1253: 2002, Iron and steel—Method for X-ray fluorescence spectrometric analysis specified in JIS G 1256: 1997, and gravimetry, titrimetry, and absorption spectroscopy specified in JIS G 1211 to G 1237.

Specifically, for example, an optical emission spectrometer for solids manufactured by SPECTRO Analytical Instruments GmbH, particularly a spark discharge optical emission spectrometer, model: Spectrolab, type: LAVMB08A, or an ICP device, model: CIROS-120 manufactured by Rigaku Corporation is exemplified.

Further, in particular, when C (carbon) and S (sulfur) are determined, an infrared absorption method after combustion in a stream of oxygen (after combustion in a high-frequency induction heating furnace) specified in JIS G 1211: 2011 is also used. Specifically, a carbon/sulfur analyzer, CS-200 manufactured by LECO Corporation is exemplified.

Further, in particular, when N (nitrogen) and O (oxygen) are determined, Iron and steel—Method for determination of nitrogen content specified in JIS G 1228 (2006) and Method for determination of oxygen content in metallic materials specified in JIS Z2613 (2006) are also used. Specifically, an oxygen/nitrogen analyzer, TC-300/EF-300 manufactured by LECO Corporation is exemplified.

The soft magnetic powder according to the embodiment contains a crystalline structure having a crystalline particle diameter of 1.0 nm or more and 30.0 nm or less at 30 vol % or more. The crystalline structure having such a particle diameter is small, and therefore, the magnetocrystalline anisotropy in each crystalline particle is easily averaged out. Therefore, the coercive force can be decreased, and a powder that is especially magnetically soft is obtained. In addition, when the crystalline structure having such a particle diameter is contained in a given amount or more, the magnetic permeability of the soft magnetic powder becomes high. As a result, a powder rich in soft magnetism, namely, having a low coercive force and a high magnetic permeability is obtained. Then, by containing the crystalline structure having such a particle diameter in an amount not lower than the above lower limit, such an effect is sufficiently obtained.

The content ratio of the crystalline structure having a particle diameter within the above range is set to 30 vol % or more, but is preferably set to 40 vol % or more and 99 vol % or less, more preferably set to 55 vol % or more and 95 vol % or less. When the content ratio of the crystalline structure having a particle diameter within the above range is less than the above lower limit, the ratio of the crystalline structure having a small particle diameter is decreased, and therefore, the averaging out of magnetocrystalline anisotropy by the exchange interaction of crystalline particles becomes insufficient, and thus, the magnetic permeability of the soft magnetic powder may be decreased or the coercive force of the soft magnetic powder maybe increased. On the other hand, the content ratio of the crystalline structure having a particle diameter within the above range may exceed the above upper limit, however, as described later, the effect of coexistence of an amorphous structure may become insufficient.

Further, the soft magnetic powder according to the embodiment may contain a crystalline structure having a particle diameter outside the above range, that is, a particle diameter less than 1.0 nm or exceeding 30.0 nm. In such a case, the content ratio of the crystalline structure having a particle diameter outside the above range is suppressed to preferably 10 vol % or less, more preferably 5 vol % or less. According to this, a decrease in the above-mentioned effect due to the crystalline structure having a particle diameter outside the above range can be suppressed.

The particle diameter of the crystalline structure of the soft magnetic powder is determined by, for example, a method in which a cut face of the soft magnetic powder is observed using an electron microscope and the particle diameter is read from the observation image. In this method, a perfect circle having the same area as that of the crystalline structure is assumed, and a diameter of the perfect circle, that is a circle equivalent diameter can be regarded as the particle diameter of the crystalline structure.

The content ratio (vol %) of the crystalline structure is determined as the degree of crystallinity based on the following formula from a spectrum obtained by X-ray diffractometry with respect to the soft magnetic powder.

Degree of crystallinity (%)={intensity derived from crystalline phase/(intensity derived from crystalline phase+intensity derived from amorphous phase)}×100

Further, as an X-ray diffractometer, for example, RINT2500V/PC manufactured by Rigaku Corporation is used.

Further, in the soft magnetic powder according to the embodiment, the average particle diameter of the crystalline structure is preferably 2.0 nm or more and 25.0 nm or less, more preferably 5.0 nm or more and 20.0 nm or less. According to this, the above-mentioned effect, that is, the effect of decreasing the coercive force and increasing the magnetic permeability becomes more pronounced, and a powder that is especially magnetically soft is obtained.

The average particle diameter of the crystalline structure of the soft magnetic powder is determined by, for example, a method in which the width of a peak derived from Fe in an X-ray diffraction pattern of the soft magnetic powder is obtained, and the average particle diameter is calculated from the value using the Halder-Wagner method other than the method in which the particle diameter of the crystalline structure is obtained and the obtained particle diameter is averaged out as described above.

On the other hand, the soft magnetic powder according to the embodiment may further contain an amorphous structure. By the coexistence of the crystalline structure having a particle diameter within the above range and the amorphous structure, the magnetostriction is cancelled out by each other, and therefore, the magnetostriction of the soft magnetic powder can be further decreased. As a result, a soft magnetic powder having a particularly high magnetic permeability is obtained. In addition, a soft magnetic powder whose magnetization is easily controlled is obtained as well.

In such a case, the content ratio of the amorphous structure is preferably 5.0 times or less, more preferably 0.020 times or more and 2.0 times or less, further more preferably 0.10 times or more and less than 1.0 times the content ratio of the crystalline structure having a particle diameter within the above range in volume ratio. According to this, the balance between the crystalline structure and the amorphous structure is optimized, and thus, the effect of the coexistence of the crystalline structure and the amorphous structure is more pronounced.

Further, in the soft magnetic powder according to the embodiment, the Vickers hardness of the particles is set to preferably 1000 or more and 3000 or less, more preferably 1200 or more and 2500 or less. The soft magnetic powder having such a hardness can minimize the deformation at a contact point between the particles when the soft magnetic powder is formed into a powder magnetic core by compression molding. Therefore, a contact area is suppressed small, resulting in increasing the resistivity of a green compact of the soft magnetic powder. As a result, a high insulating property between the particles can be more highly ensured when the powder is compacted.

If the Vickers hardness is less than the above lower limit, when the soft magnetic powder is compression molded, the particles may be likely to be crushed at the contact point between the particles depending on the average particle diameter of the soft magnetic powder. Due to this, the contact area becomes large, and the resistivity of a green compact of the soft magnetic powder becomes small, and therefore, the insulating property between the particles may be deteriorated. On the other hand, if the Vickers hardness exceeds the above upper limit, the powder compactibility is decreased depending on the average particle diameter of the soft magnetic powder, resulting in decreasing the density when the soft magnetic powder is formed into a powder magnetic core, and therefore, the magnetic properties of the powder magnetic core may be deteriorated.

The Vickers hardness of the particles of the soft magnetic powder is measured by a micro Vickers hardness tester in a central portion of the cross section of the particle. The □central portion of the cross section of the particle□ refers to a portion corresponding to the midpoint of a major axis that is the maximum length of the particle on a cut face when the particle is cut along the major axis. Further, the load of pushing an indenter when performing the test is set to 1.96 N.

The average particle diameter D50 of the soft magnetic powder according to the embodiment is not particularly limited, but is preferably 1.0 μm or more and 50 μm or less, more preferably 10 μm or more and 45 μm or less, further more preferably 20 μm or more and 40 μm or less. By using the soft magnetic powder having such an average particle diameter, a path through which an eddy current flows can be shortened, and therefore, a powder magnetic core capable of sufficiently suppressing eddy current loss generated in the particles of the soft magnetic powder can be produced.

When the average particle diameter is 10 μm or more, by mixing with a powder having an average particle diameter smaller than that, a mixed powder capable of realizing a high compacted density can be produced. As a result, the packed density of the powder magnetic core is increased, and the magnetic flux density and the magnetic permeability of the powder magnetic core can be increased.

The average particle diameter D50 of the soft magnetic powder is determined as a particle diameter when the cumulative frequency from the small diameter side reaches 50% in a mass-based particle size distribution obtained by laser diffractometry.

When the average particle diameter of the soft magnetic powder is less than the above lower limit, the soft magnetic powder becomes too fine, and therefore, the packing property of the soft magnetic powder may be likely to be deteriorated. Due to this, the molded density of the powder magnetic core that is one example of the green compact is decreased, and thus, the magnetic flux density or the magnetic permeability of the powder magnetic core may be decreased depending on the material composition or the mechanical properties of the soft magnetic powder. On the other hand, when the average particle diameter of the soft magnetic powder exceeds the above upper limit, the eddy current loss generated in the particles cannot be sufficiently suppressed depending on the material composition or the mechanical properties of the soft magnetic powder, and therefore, the iron loss of the powder magnetic core may be increased.

Further, in a mass-based particle size distribution obtained by laser diffractometry with respect to the soft magnetic powder according to the embodiment, when the particle diameter at a cumulative frequency from the small diameter side of 10% is represented by D10 and the particle diameter at a cumulative frequency from the small diameter side of 90% is represented by D90, (D90−D10)/D50 is preferably about 1.0 or more and 2.5 or less, more preferably about 1.2 or more and 2.3 or less. (D90−D10)/D50 is an index indicating the degree of spreading of the particle size distribution, and when this index is within the above range, the packing property of the soft magnetic powder is favorable. Due to this, a green compact having particularly high magnetic properties such as magnetic permeability and magnetic flux density is obtained.

The coercive force of the soft magnetic powder according to the embodiment is not particularly limited, but is preferably 2.0 Oe or less (160 A/m or less), more preferably 0.1 Oe or more and 1.5 Oe or less (39.9 A/m or more and 120 A/m or less). By using the soft magnetic powder having such a low coercive force, a powder magnetic core capable of sufficiently suppressing the hysteresis loss even at a high frequency can be produced.

The coercive force of the soft magnetic powder can be measured using, for example, a vibrating sample magnetometer such as TM-VSM 1230-MHHL, manufactured by Tamakawa Co., Ltd.

Further, when the soft magnetic powder according to the embodiment is formed into a green compact, the magnetic permeability of the green compact at a measurement frequency of 1 MHz is preferably 15 or more, more preferably 18 or more and 50 or less. Such a soft magnetic powder contributes to the realization of a powder magnetic core having excellent magnetic properties. Further, the soft magnetic powder has a relatively high magnetic permeability, and therefore also contributes to the enhancement of the efficiency of a magnetic element.

The magnetic permeability is a relative magnetic permeability (effective magnetic permeability) determined from the self-inductance of a closed magnetic circuit magnetic core coil when a green compact is formed into a toroidal shape. In the measurement of the magnetic permeability, for example, an impedance analyzer such as 4194A, manufactured by Agilent Technologies, Inc. is used, and the measurement frequency is set to 1 MHz. Further, the number of turns of a winding is set to 7, and the wire diameter of the winding is set to 0.5 mm.

### Powder Magnetic Core and Magnetic Element

Next, respective embodiments of the powder magnetic core and the magnetic element will be described.

The magnetic element according to the embodiment can be applied to, for example, various magnetic elements including a magnetic core such as a choke coil, an inductor, a noise filter, a reactor, a transformer, a motor, an actuator, a solenoid valve, and an electrical generator. Further, the powder magnetic core according to the embodiment can be applied to a magnetic core included in these magnetic elements.

Hereinafter, as one example of the magnetic element, two types of choke coils will be representatively described.

### First Embodiment

First, a choke coil to which the first embodiment of the magnetic element is applied will be described.

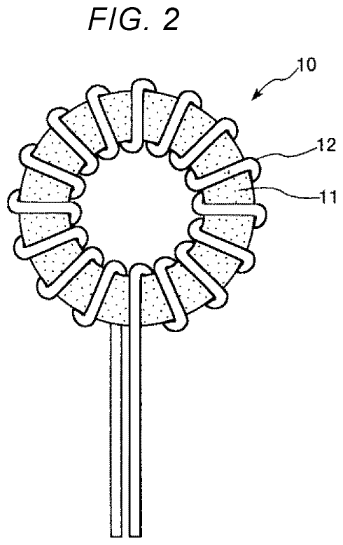

FIG. 2 is a plan view schematically showing a choke coil to which the first embodiment of the magnetic element is applied.

A choke coil 10 (the magnetic element according to this embodiment) shown in FIG. 2 includes a powder magnetic core 11 having a ring shape (toroidal shape) and a conductive wire 12 wound around the powder magnetic core 11. Such a choke coil 10 is generally referred to as □toroidal coil□.

The powder magnetic core 11 (the powder magnetic core according to this embodiment) is obtained by mixing the soft magnetic powder according to the embodiment, a binding material (binder), and an organic solvent, supplying the obtained mixture in a molding die, and press molding the mixture. That is, the powder magnetic core 11 is a green compact containing the soft magnetic powder according to the embodiment. Such a powder magnetic core 11 has small iron loss. As a result, when the powder magnetic core 11 is mounted on an electronic device or the like, the power consumption of the electronic device or the like can be reduced or the performance thereof can be enhanced, and thus, it can contribute to the improvement of the reliability of the electronic device or the like.

The binding material or the organic solvent may be added as needed, and may be omitted.

Further, as described above, the choke coil 10 that is one example of the magnetic element includes the powder magnetic core 11. Therefore, the choke coil 10 has reduced iron loss and enhanced performance. As a result, when the choke coil 10 is mounted on an electronic device or the like, the power consumption of the electronic device or the like can be reduced or the performance thereof can be enhanced, and thus, it can contribute to the improvement of the reliability of the electronic device or the like.

Examples of the constituent material of the binding material to be used for producing the powder magnetic core 11 include organic materials such as a silicone-based resin, an epoxy-based resin, a phenolic resin, a polyamide-based resin, a polyimide-based resin, and a polyphenylene sulfide-based resin, and inorganic materials such as phosphates such as magnesium phosphate, calcium phosphate, zinc phosphate, manganese phosphate, and cadmium phosphate, and silicates (liquid glass) such as sodium silicate, and particularly, a thermosetting polyimide or an epoxy-based resin is preferred. Such a resin material is easily cured by heating and has excellent heat resistance. Therefore, the ease of production of the powder magnetic core 11 and also the heat resistance thereof can be increased.

The ratio of the binding material to the soft magnetic powder slightly varies depending on the desired magnetic flux density and mechanical properties, the allowable eddy current loss, etc. of the powder magnetic core 11 to be produced, but is preferably about 0.5 mass % or more and 5 mass % or less, more preferably about 1 mass % or more and 3 mass % or less. According to this, the powder magnetic core 11 having excellent magnetic properties such as magnetic flux density and magnetic permeability can be obtained while sufficiently binding the respective particles of the soft magnetic powder.

The organic solvent is not particularly limited as long as it can dissolve the binding material, but examples thereof include various solvents such as toluene, isopropyl alcohol, acetone, methyl ethyl ketone, chloroform, and ethyl acetate.

To the above-mentioned mixture, any of various additives may be added for an arbitrary purpose as needed.

Examples of the constituent material of the conductive wire 12 include materials having high electrical conductivity, for example, metal materials including Cu, Al, Ag, Au, Ni, and the like.

It is preferred that the surface of the conductive wire 12 is provided with a surface layer having an insulating property. According to this, a short circuit between the powder magnetic core 11 and the conductive wire 12 can be reliably prevented. Examples of the constituent material of such a surface layer include various resin materials. Further, a similar surface layer may be provided on the surface of the powder magnetic core 11, and the surface layer maybe provided on both.

Next, a method for producing the choke coil 10 will be described.

First, the soft magnetic powder according to the embodiment, a binding material, all sorts of necessary additives, and an organic solvent are mixed, whereby a mixture is obtained.

Subsequently, the mixture is dried to obtain a block-shaped dry material. Then, the obtained dry material is pulverized, whereby a granulated powder is formed.

Subsequently, this granulated powder is molded into the shape of a powder magnetic core to be produced, whereby a molded body is obtained.

A molding method in this case is not particularly limited, however, examples thereof include press molding, extrusion molding, and injection molding. The shape and size of this molded body are determined in anticipation of shrinkage when heating the molded body in the subsequent process. Further, the molding pressure in the case of press molding is set to about 1 t/cm² (98 MPa) or more and 10 t/cm² (981 MPa) or less.

Subsequently, by heating the obtained molded body, the binding material is cured, whereby the powder magnetic core 11 is obtained. The heating temperature at this time slightly varies depending on the composition of the binding material and the like, however, when the binding material is composed of an organic material, the heating temperature is set to preferably about 100° C. or higher and 500° C. or lower, more preferably about 120° C. or higher and 250° C. or lower. The heating time varies depending on the heating temperature, but is set to about 0.5 hours or more and 5 hours or less.

In the above manner, the choke coil 10 (the magnetic element according to the embodiment) including the powder magnetic core 11 obtained by press molding the soft magnetic powder according to the embodiment and the conductive wire 12 wound around the powder magnetic core 11 along the outer circumferential face thereof is obtained.

The shape of the powder magnetic core 11 is not limited to the ring shape shown in FIG. 2, and may be, for example, a shape in which part of a ring is missing or may be a shape in which the shape in the longitudinal direction is straight.

Further, the powder magnetic core 11 may contain a soft magnetic powder other than the soft magnetic powder according to the above-mentioned embodiment or a nonmagnetic powder as needed.

### Second Embodiment

Next, a choke coil to which a second embodiment of the magnetic element is applied will be described.

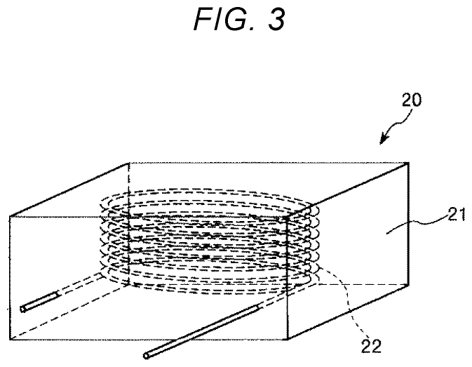

FIG. 3 is a transparent perspective view schematically showing a choke coil to which a second embodiment of the magnetic element is applied.

Hereinafter, the choke coil according to the second embodiment will be described, however, in the following description, different points from the choke coil according to the above-mentioned first embodiment will be mainly described and the description of the same matter will be omitted.

As shown in FIG. 3, a choke coil 20 according to this embodiment is configured such that a conductive wire 22 molded into a coil shape is embedded inside a powder magnetic core 21. That is, the choke coil 20 is obtained by molding the conductive wire 22 with the powder magnetic core 21. This powder magnetic core 21 has the same configuration as the above-mentioned powder magnetic core 11.

As the choke coil 20 having such a configuration, a relatively small choke coil is easily obtained. When such a small choke coil 20 is produced, by using the powder magnetic core 21 having a high magnetic flux density and a high magnetic permeability and also having small loss, the choke coil 20 having small loss and generating low heat so as to be able to cope with a large electric current although the size is small is obtained.

Further, since the conductive wire 22 is embedded inside the powder magnetic core 21, a gap is hardly generated between the conductive wire 22 and the powder magnetic core 21. According to this, vibration of the powder magnetic core 21 due to magnetostriction is suppressed, and thus, it is also possible to suppress generation of noise accompanying this vibration.

When the choke coil 20 according to this embodiment as described above is produced, first, the conductive wire 22 is disposed in the cavity of a molding die, and also the granulated powder containing the soft magnetic powder according to the embodiment is packed in the cavity. That is, the granulated powder is packed so as to include the conductive wire 22 therein.

Subsequently, the granulated powder is pressed together with the conductive wire 22, whereby a molded body is obtained.

Subsequently, in the same manner as in the above-mentioned first embodiment, the obtained molded body is subjected to a heat treatment. By doing this, the binding material is cured, whereby the powder magnetic core 21 and the choke coil 20 (the magnetic element according to the embodiment) are obtained.

The powder magnetic core 21 may contain a soft magnetic powder other than the soft magnetic powder according to the above-mentioned embodiment or a nonmagnetic powder as needed.

### Method for Producing Soft Magnetic Powder

Next, a method for producing the soft magnetic powder will be described.

The soft magnetic powder may be produced by any production method, and is produced by, for example, any of various powdering methods such as atomization methods such as a water atomization method, a gas atomization method, and a spinning water atomization method, a reducing method, a carbonyl method, and a pulverization method.

As the atomization methods, there have been known a water atomization method, a gas atomization method, a spinning water atomization method, and the like divided according to the type of a cooling medium or the difference in device configuration. Among these, the soft magnetic powder is preferably produced by an atomization method, more preferably produced by a water atomization method or a spinning water atomization method, and furthermore preferably produced by a spinning water atomization method. The atomization method is a method in which a molten metal (metal melt) is caused to collide with a fluid such as a liquid or a gas jetted at a high speed to atomize the molten metal and also cool the atomized metal, whereby a metal powder (soft magnetic powder) is produced. By producing the soft magnetic powder using such an atomization method, an extremely fine powder can be efficiently produced. Further, the shape of the particle of the obtained powder is closer to a spherical shape by the action of surface tension. Due to this, a soft magnetic powder having a high packing factor when producing a powder magnetic core is obtained. That is, a soft magnetic powder capable of producing a powder magnetic core having a high magnetic permeability and a high magnetic flux density can be obtained.

The □water atomization method□ as used herein refers to a method in which a liquid such as water or an oil is used as a cooling liquid, and in a state where this liquid is jetted in an inverted conical shape so as to converge on one point, the molten metal is allowed to flow down toward this convergence point and collide with the cooling liquid so as to atomize the molten metal, whereby a metal powder is produced.

On the other hand, by using a spinning water atomization method, the metal melt can be cooled at an extremely high speed. Therefore, the metal melt can be solidified in a state where the chaotic atomic arrangement in the molten metal is highly maintained. Due to this, by performing a crystallization treatment thereafter, a soft magnetic powder having a crystalline structure with a uniform particle diameter can be efficiently produced.

Hereinafter, a method for producing the soft magnetic powder by a spinning water atomization method will be described.

In a spinning water atomization method, a cooling liquid is supplied by ejection along the inner circumferential face of a cooling cylindrical body, and is spun along the inner circumferential face of the cooling cylindrical body, whereby a cooling liquid layer is formed on the inner circumferential face. On the other hand, the raw material of the soft magnetic powder is melted, and while allowing the obtained molten metal to freely fall, a liquid or gas jet is blown to the molten metal. By doing this, the molten metal is scattered, and the scattered molten metal is incorporated in the cooling liquid layer. As a result, the molten metal atomized by scattering is solidified by rapid cooling, whereby the soft magnetic powder is obtained.

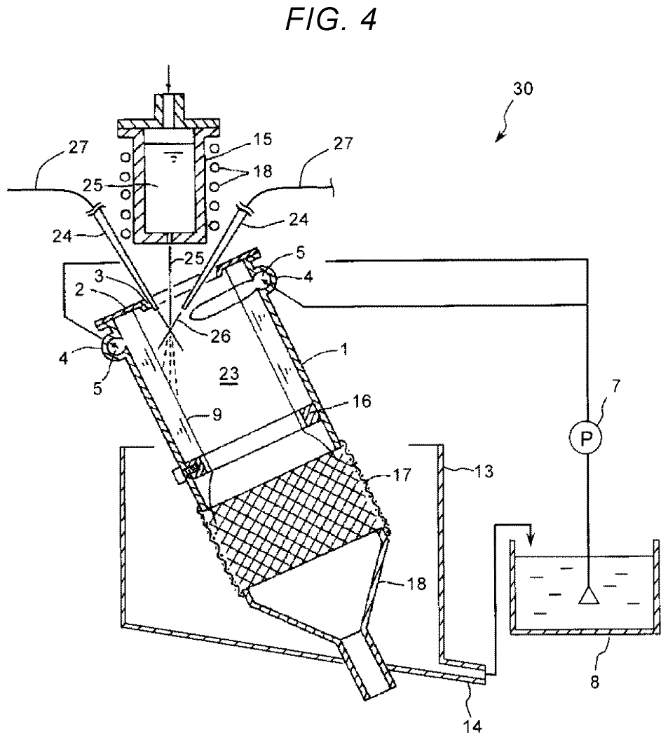

FIG. 4 is a longitudinal cross-sectional view showing one example of a device for producing the soft magnetic powder by a spinning water atomization method.

A powder production device 30 shown in FIG. 4 includes a cooling cylindrical body 1 for forming a cooling liquid layer 9 on an inner circumferential face, a crucible 15 that is a supply container for supplying and allowing a molten metal 25 to flow down into a space portion 23 inside the cooling liquid layer 9, a pump 7 that is a unit for supplying the cooling liquid to the cooling cylindrical body 1, and a jet nozzle 24 configured to eject a gas jet 26 for breaking up the flowing down molten metal 25 in a thin stream into liquid droplets and also supplying the liquid droplets to the cooling liquid layer 9. The molten metal 25 is appropriately adjusted according to the composition of the soft magnetic powder.

The cooling cylindrical body 1 has a circular cylindrical shape and is disposed so that the axial line of the cylindrical body is along the vertical direction or is tilted at an angle of 30° or less with respect to the vertical direction. Incidentally, the axial line of the cylindrical body is tilted with respect to the vertical direction in FIG. 4, however, the axial line of the cylindrical body may be in parallel with the vertical direction.

The upper end opening of the cooling cylindrical body 1 is closed by a lid 2, and in the lid 2, an opening portion 3 for supplying the flowing down molten metal 25 to the space portion 23 of the cooling cylindrical body 1 is formed.

Further, in an upper portion of the cooling cylindrical body 1, a cooling liquid ejection tube 4 configured to be able to supply the cooling liquid by ejection in the tangential direction of the inner circumferential face of the cooling cylindrical body 1 is provided. Then, a plurality of ejection ports 5 of the cooling liquid ejection tube 4 are provided at equal intervals along the circumferential direction of the cooling cylindrical body 1. Further, the tube axial direction of the cooling liquid ejection tube 4 is set so that it is tilted downward at an angle of about 0° or more and 20° or less with respect to a plane orthogonal to the axial line of the cooling cylindrical body 1.

The cooling liquid ejection tube 4 is coupled to a tank 8 through a pipe to which the pump 7 is coupled, and the cooling liquid in the tank 8 sucked by the pump 7 is supplied by ejection into the cooling cylindrical body 1 through the cooling liquid ejection tube 4. By doing this, the cooling liquid gradually flows down while spinning along the inner circumferential face of the cooling cylindrical body 1, and accompanying this, the layer of the cooling liquid along the inner circumferential face, that is, a cooling liquid layer 9 is formed. Incidentally, a cooler may be interposed as needed in the tank 8 or in the middle of the circulation flow channel. As the cooling liquid, other than water, an oil such as a silicone oil is used, and further, any of various additives may be added thereto. Further, by removing dissolved oxygen in the cooling liquid in advance, oxidation accompanying cooling of the powder to be produced can be suppressed.

Further, in a lower portion of the inner circumferential face of the cooling cylindrical body 1, a layer thickness adjustment ring 16 for adjusting the layer thickness of the cooling liquid layer 9 is detachably provided. By providing this layer thickness adjustment ring 16, the flowing down speed of the cooling liquid is controlled, and therefore, the layer thickness of the cooling liquid layer 9 is ensured, and also the uniformization of the layer thickness can be achieved. The layer thickness adjustment ring 16 may be provided as needed.

Further, in a lower portion of the cooling cylindrical body 1, a liquid draining net body 17 having a circular cylindrical shape is continuously provided, and at a lower side of this liquid draining net body 17, a powder recovery container 18 having a funnel shape is provided. Around the liquid draining net body 17, a cooling liquid recovery cover 13 is provided so as to cover the liquid draining net body 17, and a drain port 14 formed in a bottom portion of this cooling liquid recovery cover 13 is coupled to the tank 8 through a pipe.

Further, in the space portion 23, the jet nozzle 24 for ejecting a gas such as air or an inert gas is provided. This jet nozzle 24 is attached to the tip end of a gas supply tube 27 inserted through the opening portion 3 of the lid 2 and is disposed such that the ejection port thereof is oriented toward the molten metal 25 in a thin stream and further oriented toward the cooling liquid layer 9 beyond the molten metal.

When a soft magnetic powder is produced in such a powder production device 30, first, the pump 7 is operated and the cooling liquid layer 9 is formed on the inner circumferential face of the cooling cylindrical body 1, and then, the molten metal 25 in the crucible 15 is allowed to flow down into the space portion 23. When the gas jet 26 is blown to this molten metal 25, the molten metal 25 is scattered, and the atomized molten metal 25 is incorporated in the cooling liquid layer 9. As a result, the atomized molten metal 25 is cooled and solidified, whereby a soft magnetic powder is obtained.

In the spinning water atomization method, by continuously supplying the cooling liquid, an extremely high cooling rate can be stably maintained, and therefore, the degree of amorphization of a soft magnetic powder to be produced is stabilized. As a result, by performing a crystallization treatment thereafter, a soft magnetic powder having a crystalline structure with a uniform particle diameter can be efficiently produced.

Further, the molten metal 25 atomized to a given size by the gas jet 26 falls by inertia until it is incorporated in the cooling liquid layer 9. Therefore, the spheroidization of the liquid droplet is achieved at that time. As a result, a soft magnetic powder can be produced.

For example, the flow-down amount of the molten metal 25 to be allowed to flow down from the crucible 15 varies depending also on the device size and is not particularly limited, but is preferably controlled to be 1 kg or less per minute. According to this, when the molten metal 25 is scattered, it is scattered as liquid droplets with an appropriate size, and therefore, a soft magnetic powder having an average particle diameter as described above is obtained. Further, by controlling the amount of the molten metal 25 to be supplied in a given time to a certain degree, also a sufficient cooling rate is obtained, and therefore, the degree of amorphization is increased, and thus, a soft magnetic powder having a crystalline structure with a uniform particle diameter is obtained. Incidentally, for example, by decreasing the flow-down amount of the molten metal 25 within the above range, it is possible to perform adjustment such that the average particle diameter is decreased.

On the other hand, the outer diameter of the thin stream of the molten metal 25 to be allowed to flow down from the crucible 15, in other words, the inner diameter of a flow-down port of the crucible 15 is not particularly limited, but is preferably 1 mm or less. According to this, it becomes easy to make the gas jet 26 uniformly hit the thin stream of the molten metal 25, and therefore, it becomes easy to uniformly scatter the liquid droplets with an appropriate size. As a result, a soft magnetic powder having an average particle diameter as described above is obtained. Then, also in this case, the amount of the molten metal 25 to be supplied in a given time is controlled, and therefore, a cooling rate is also sufficiently obtained, and thus, sufficient amorphization can be achieved.

Further, the flow rate of the gas jet 26 is not particularly limited, but is preferably set to 100 m/s or more and 1000 m/s or less. According to this, also in this case, the molten metal 25 can be scattered as liquid droplets with an appropriate size, and therefore, a soft magnetic powder having an average particle diameter as described above is obtained. Further, the gas jet 26 has a sufficient speed, and therefore, a sufficient speed is also given to the scattered liquid droplets, and therefore, the liquid droplets become finer, and also the time until the liquid droplets are incorporated in the cooling liquid layer 9 is shortened. As a result, the liquid droplets can be spheroidized in a short time and also cooled in a short time, and thus, further amorphization is achieved. For example, by increasing the flow rate of the gas jet 26 within the above range, it is possible to perform adjustment such that the average particle diameter is decreased.

Further, as other conditions, for example, it is preferred that the pressure when ejecting the cooling liquid to be supplied to the cooling cylindrical body 1 is set to about 50 MPa or more and 200 MPa or less, the liquid temperature is set to about −10° C. or higher and 40° C. or lower. According to this, the flow rate of the cooling liquid layer 9 is optimized, and the atomized molten metal 25 can be appropriately and evenly cooled.

Further, when the raw material of the soft magnetic powder is melted, the melting temperature is preferably set to about Tm+20° C. or higher and Tm+200° C. or lower, more preferably set to about Tm+50° C. or higher and Tm+150° C. or lower wherein Tm is the melting point of the raw material. According to this, when the molten metal 25 is atomized by the gas jet 26, the variation in the properties among the particles can be suppressed particularly small, and also the amorphization of the soft magnetic powder can be more reliably achieved.

The gas jet 26 can also be substituted by a liquid jet as needed.

The cooling rate when cooling the molten metal 25 in the atomization method is preferably 1×10⁴ ° C./s or more, more preferably 1×10⁵ ° C./s or more. By the rapid cooling in this manner, a soft magnetic powder having a particularly high degree of amorphization is obtained, and a soft magnetic powder having a crystalline structure with a uniform particle diameter is finally obtained. In addition, a variation in the compositional ratio among the particles of the soft magnetic powder can be suppressed.

The soft magnetic powder produced as described above is subjected to a crystallization treatment. By doing this, at least part of the amorphous structure is crystallized, whereby a crystalline structure is formed.

The crystallization treatment can be performed by subjecting the soft magnetic powder containing an amorphous structure to a heat treatment. The temperature of the heat treatment is not particularly limited, but is preferably 520° C. or higher and 640° C. or lower, more preferably 530° C. or higher and 630° C. or lower, furthermore preferably 540° C. or higher and 620° C. or lower. As for the time of the heat treatment, the maintaining time at the above-mentioned temperature is set to preferably 1 minute or more and 180 minutes or less, more preferably 3 minutes or more and 120 minutes or less, further more preferably 5 minutes or more and 60 minutes or less. By setting the temperature and time of the heat treatment within the above ranges, respectively, the crystalline structure having a more uniform particle diameter can be more equally generated. As a result, a soft magnetic powder containing a crystalline structure having a particle diameter of 1.0 nm or more and 30.0 nm or less at 30 vol % or more is obtained. This is considered to be because by incorporating a crystalline structure having a small and uniform particle diameter in a large amount to some extent, for example, at 30 vol % or more, an interaction at the interface between the crystalline structure and the amorphous structure is particularly dominant, and accompanying this, the hardness is increased as compared with a case where an amorphous structure is dominant or a case where a crystalline structure having a large particle diameter is contained in a large amount.

When the temperature or time of the heat treatment is less than the above lower limit, depending on the material composition of the soft magnetic powder or the like, the crystallization becomes insufficient, and also the uniformity of the particle diameter is poor, and therefore, the interaction at the interface between the crystalline structure and the amorphous structure cannot be obtained, and thus, the hardness may become insufficient. Due to this, the resistivity in a green compact is decreased, and thus, a high insulating property between the particles may not be able to be ensured. On the other hand, when the temperature or time of the heat treatment exceeds the above upper limit, depending on the material composition of the soft magnetic powder or the like, crystallization excessively proceeds, and also the uniformity of the particle diameter is poor, and therefore, the interface between the crystalline structure and the amorphous structure is decreased, and also in this case, the hardness may become insufficient. Due to this, the resistivity in a green compact is decreased, and therefore, a high insulating property between the particles may not be able to be ensured.

The atmosphere of the crystallization treatment is not particularly limited, but is preferably an inert gas atmosphere such as nitrogen or argon, a reducing gas atmosphere such as hydrogen or an ammonia decomposition gas, or a reduced pressure atmosphere thereof. According to this, crystallization can be achieved while suppressing oxidation of the metal, and thus, a soft magnetic powder having excellent magnetic properties is obtained.

In the above manner, the soft magnetic powder according to this embodiment can be produced.

The thus obtained soft magnetic powder may be subjected to classification as needed. Examples of the classification method include dry classification such as sieve classification, inertial classification, centrifugal classification, and wind power classification, and wet classification such as sedimentation classification.

Further, an insulating film may be formed on the surface of each particle of the obtained soft magnetic powder as needed. Examples of the constituent material of this insulating film include inorganic materials such as phosphates such as magnesium phosphate, calcium phosphate, zinc phosphate, manganese phosphate, and cadmium phosphate, and silicates (liquid glass) such as sodium silicate. Further, it may be a material appropriately selected from the organic materials listed as the constituent material of the binding material described later.

### Electronic Device

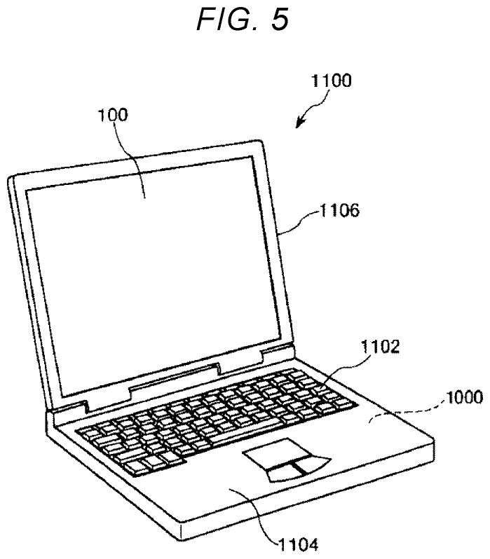

Next, an electronic device (an electronic device according to an embodiment) including the magnetic element according to the embodiment will be described in detail with reference to FIGS. 5 to 7.

FIG. 5 is a perspective view showing a configuration of a mobile-type personal computer, to which an electronic device including the magnetic element according to the embodiment is applied. In this drawing, a personal computer 1100 includes a body portion 1104 provided with a key board 1102, and a display unit 1106 provided with a display portion 100. The display unit 1106 is supported rotatably with respect to the body portion 1104 via a hinge structure. Such a personal computer 1100 includes a built-in magnetic element 1000, for example, a choke coil or an inductor for a switched-mode power supply, a motor, or the like.

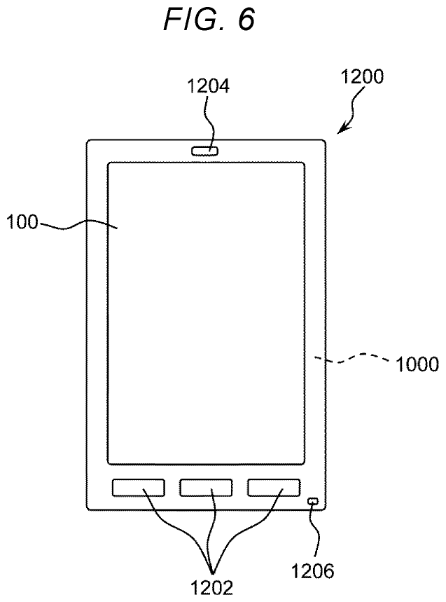

FIG. 6 is a plan view showing a configuration of a smartphone, to which an electronic device including the magnetic element according to the embodiment is applied. In this drawing, a smartphone 1200 includes a plurality of operation buttons 1202, an earpiece 1204, and a mouthpiece 1206, and between the operation buttons 1202 and the earpiece 1204, a display portion 100 is disposed. Such a smartphone 1200 includes a built-in magnetic element 1000, for example, an inductor, a noise filter, a motor, or the like.

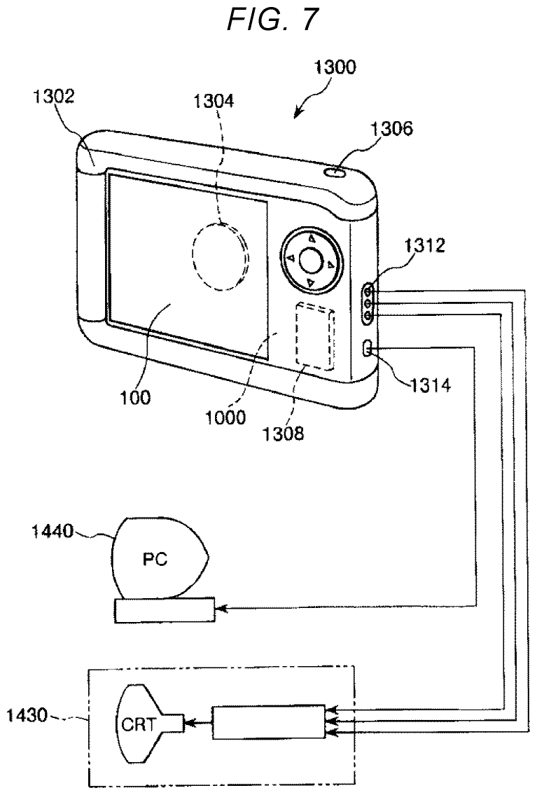

FIG. 7 is a perspective view showing a configuration of a digital still camera, to which an electronic device including the magnetic element according to the embodiment is applied. In this drawing, coupling to external devices is also briefly shown. A digital still camera 1300 generates an image capture signal by photoelectrically converting an optical image of a subject by an image capture device such as a CCD (Charge Coupled Device).

At a back face of a case 1302 in the digital still camera 1300, a display portion 100 is provided, and the display portion 100 is configured to display an image captured based on the image capture signal by the CCD. The display portion 100 functions as a finder displaying a subject as an electronic image. Further, at a front face side of the case 1302, that is, at a rear face side in the drawing, a light receiving unit 1304 including an optical lens (an image capture optical system), a CCD, or the like is provided.

When a person who takes a picture confirms an image of a subject displayed in the display portion 100 and presses a shutter button 1306, an image capture signal of the CCD at that time is transferred and stored in a memory 1308. Further, a video signal output terminal 1312 and an input/output terminal 1314 for data communication are provided at a side face of the case 1302 in this digital still camera 1300. As shown in the drawing, a television monitor 1430 is coupled to the video signal output terminal 1312 and a personal computer 1440 is coupled to the input/output terminal 1314 for data communication as needed. Moreover, the digital still camera 1300 is configured such that the image capture signal stored in the memory 1308 is output to the television monitor 1430 or the personal computer 1440 by a predetermined operation. Also in such a digital still camera 1300, the magnetic element 1000, for example, an inductor, a noise filter, or the like is incorporated.

Examples of the electronic device according to the embodiment include a cellular phone, a tablet terminal, a timepiece, an inkjet-type ejection device such as an inkjet printer, a laptop-type personal computer, a television, a video camera, a videotape recorder, a car navigation device, a pager, an electronic organizer, an electronic dictionary, an electronic calculator, an electronic gaming machine, a word processor, a workstation, a videophone, a television monitor for crime prevention, electronic binoculars, a POS terminal, medical devices such as an electronic thermometer, a blood pressure meter, a blood sugar meter, an electrocardiogram monitoring device, an ultrasound diagnostic device, and an electronic endoscope, a fish finder, various measurement devices, meters and gauges for vehicles, airplanes, and ships, moving object control devices such as a car control device, an airplane control device, a railroad vehicle control device, and a ship control device, and a flight simulator other than the personal computer shown in FIG. 5, the smartphone shown in FIG. 6, and the digital still camera shown in FIG. 7.

As described above, such an electronic device includes the magnetic element according to the embodiment. Therefore, the effect of the magnetic element having low iron loss and high performance can be enjoyed and the reliability of the electronic device can be increased.

Hereinabove, the soft magnetic powder, the powder magnetic core, the magnetic element, and the electronic device according to the present disclosure have been described based on the preferred embodiments, but the present disclosure is not limited thereto.

For example, in the above-mentioned embodiments, as the example of application of the soft magnetic powder according to the present disclosure, the powder magnetic core is described, however, the example of application is not limited thereto, and for example, it may be applied to a magnetic fluid, a magnetic shielding sheet, or a magnetic device such as a magnetic head.

Further, the shapes of the powder magnetic core and the magnetic element are also not limited to those shown in the drawings, and may be any shapes.

### EXAMPLES

Next, specific examples of the present disclosure will be described.

### 1. Production of Powder Magnetic Core

### Sample No. 1

[1] First, the raw material was melted in a high-frequency induction furnace, and also powdered by a spinning water atomization method, whereby a soft magnetic powder was obtained. At this time, the flow-down amount of the molten metal to be allowed to flow down from the crucible was set to 0.5 kg/min, the inner diameter of the flow-down port of the crucible was set to 1 mm, and the flow rate of the gas jet was set to 900 m/s. Subsequently, classification was performed by a wind power classifier. The alloy composition of the obtained soft magnetic powder is shown in Table 1. In the determination of the alloy composition, an optical emission spectrometer for solids (a spark optical emission analyzer), model: Spectrolab, type: LAVMB08A manufactured by SPECTRO Analytical Instruments GmbH was used. As a result, the total content of impurities was 0.50 at % or less. Further, particularly, the content of Al (aluminum) was 0.03 at % or less, and the content of Ti (titanium) was 0.02 at % or less.

[2] Subsequently, with respect to the obtained soft magnetic powder, a particle size distribution was measured. This measurement was performed using Microtrack HRA9320-X100, manufactured by Nikkiso Co., Ltd. that is a laser diffraction particle size distribution analyzer. Then, the average particle diameter D50 of the soft magnetic powder was determined from the particle size distribution and found to be 20 μm. Further, with respect to the obtained soft magnetic powder, it was evaluated whether or not the structure before the heat treatment is amorphous by an X-ray diffractometer.

[3] Subsequently, the obtained soft magnetic powder was heated to 560° C. for 15 minutes in a nitrogen atmosphere. By doing this, the amorphous structure in the particles was crystallized.

[4] Subsequently, the obtained soft magnetic powder was mixed with an epoxy resin that is a binding material and toluene that is an organic solvent, whereby a mixture was obtained. The addition amount of the epoxy resin was set to 2 parts by mass with respect to 100 parts by mass of the soft magnetic powder.

[5] Subsequently, the obtained mixture was stirred, and then dried in a short time, whereby a block-shaped dry material was obtained. Then, the thus obtained dry material was sieved through a sieve with a mesh size of 400 μm, and then pulverized, whereby a granulated powder was obtained. The obtained granulated powder was dried at 50° C. for 1 hour.

[6] Subsequently, the obtained granulated powder was packed in a molding die, and a molded body was obtained under the following molding conditions.

Molding Conditions
Molding method: press molding
Shape of molded body: ring shape
Size of molded body: outer diameter: 14 mm, inner diameter: 8 mm, thickness: 3 mm
Molding pressure: 3 t/cm² (294 MPa)

[7] Subsequently, the molded body was heated in an air atmosphere at a temperature of 150° C. for 0.50 hours to cure the binding material. By doing this, a powder magnetic core was obtained.

### Sample Nos. 2 to 15

Powder magnetic cores were obtained in the same manner as Sample No. 1 except that as the soft magnetic powder, those shown in Table 1 were used, respectively. The average particle diameter D50 of each sample fell within a range of 10 μm or more and 30 μm or less. The heating temperature for crystallization was appropriately set within a range from 470 to 600° C. so as to minimize the coercive force in each sample.

TABLE 1

| | | | Alloy composition, etc. | | | | | | | | | | | | |
|---|---|---|---|---|---|---|---|---|---|---|---|---|---|---|---|
| | Example/ | Type of | Fe | Cu | Nb | Zn | | | C | | | | | Zn/(Nb + Zn) | Region |
| Sample | Comparative | atomization | x | a | b | | Si | B | c | Total | Si + B | B/(Si + B) | C/B | z | A |
| No. | Example | method | at % | | | | | | | at % | | y | — | — | — |
| No. 1 | Comparative | spinning water | 73.5 | 1.0 | | 3.0 | 18.0 | 4.5 | | 100 | 22.5 | 0.20 | 0.00 | 1.00 | — |
| | Example | | | | | | | | | | | | | | |
| No. 2 | Example | spinning water | 73.5 | 1.0 | | 3.0 | 15.8 | 6.8 | | 100 | 22.5 | 0.30 | 0.00 | 1.00 | A |
| No. 3 | Example | spinning water | 73.5 | 1.0 | | 3.0 | 13.5 | 9.0 | | 100 | 22.5 | 0.40 | 0.00 | 1.00 | A |
| No. 4 | Example | spinning water | 73.5 | 1.0 | | 3.0 | 11.3 | 11.3 | | 100 | 22.5 | 0.50 | 0.00 | 1.00 | A |
| No. 5 | Example | spinning water | 73.5 | 1.0 | | 3.0 | 9.0 | 13.5 | | 100 | 22.5 | 0.60 | 0.00 | 1.00 | A |
| No. 6 | Example | spinning water | 73.5 | 1.0 | | 3.0 | 6.8 | 15.8 | | 100 | 22.5 | 0.70 | 0.00 | 1.00 | A |
| No. 7 | Example | spinning water | 75.0 | 1.0 | | 3.0 | 6.3 | 14.7 | | 100 | 21.0 | 0.70 | 0.00 | 1.00 | A |
| No. 8 | Comparative | spinning water | 77.0 | 1.0 | | 3.0 | 9.5 | 9.5 | | 100 | 19.0 | 0.50 | 0.00 | 1.00 | — |
| | Example | | | | | | | | | | | | | | |
| No. 9 | Example | spinning water | 77.0 | 1.0 | | 3.0 | 7.6 | 11.4 | | 100 | 19.0 | 0.60 | 0.00 | 1.00 | A |
| No. 10 | Example | spinning water | 77.0 | 1.0 | | 3.0 | 5.7 | 13.3 | | 100 | 19.0 | 0.70 | 0.00 | 1.00 | A |
| No. 11 | Example | spinning water | 78.0 | 1.0 | | 3.0 | 5.4 | 12.6 | | 100 | 18.0 | 0.70 | 0.00 | 1.00 | A |
| No. 12 | Example | spinning water | 78.0 | 1.0 | | 3.0 | 1.8 | 16.2 | | 100 | 18.0 | 0.90 | 0.00 | 1.00 | A |
| No. 13 | Comparative | spinning water | 79.0 | 1.0 | | 3.0 | 5.1 | 11.9 | | 100 | 17.0 | 0.70 | 0.00 | 1.00 | — |
| | Example | | | | | | | | | | | | | | |
| No. 14 | Example | spinning water | 79.0 | 1.0 | | 3.0 | 1.7 | 15.3 | | 100 | 17.0 | 0.90 | 0.00 | 1.00 | A |
| No. 15 | Comparative | spinning water | 80.0 | 1.0 | | 3.0 | 1.6 | 14.4 | | 100 | 16.0 | 0.90 | 0.00 | 1.00 | — |
| | Example | | | | | | | | | | | | | | |

### Sample Nos. 16 to 32

Powder magnetic cores were obtained in the same manner as Sample No. 1 except that as the soft magnetic powder, those shown in Table 2 were used, respectively. The average particle diameter D50 of each sample fell within a range of 10 μm or more and 30 μm or less. The heating temperature for crystallization was appropriately set within a range from 470 to 600° C. so as to minimize the coercive force in each sample.

TABLE 2

| | | | Alloy composition, etc. | | | | | | | | | | | | |
|---|---|---|---|---|---|---|---|---|---|---|---|---|---|---|---|
| | Example/ | Type of | Fe | Cu | Nb | Zn | | | C | | | | | Zn/(Nb + Zn) | Region |
| Sample | Comparative | atomization | x | a | b | | Si | B | c | Total | Si + B | B/(Si + B) | C/B | z | A |
| No. | Example | method | at % | | | | | | | at % | | y | — | — | — |
| No. 16 | Comparative | spinning water | 73.5 | 1.0 | 3.0 | | 18.0 | 4.5 | | 100 | 22.5 | 0.20 | 0.00 | 0.00 | — |
| | Example | | | | | | | | | | | | | | |
| No. 17 | Example | spinning water | 77.0 | 1.0 | 1.0 | 1.0 | 8.0 | 12.0 | | 100 | 20.0 | 0.60 | 0.00 | 0.50 | A |
| No. 18 | Example | spinning water | 77.0 | 1.0 | 1.5 | 1.5 | 5.7 | 13.3 | | 100 | 19.0 | 0.70 | 0.00 | 0.50 | A |
| No. 19 | Example | spinning water | 77.0 | 1.0 | 1.0 | 1.5 | 7.8 | 11.7 | | 100 | 19.5 | 0.60 | 0.00 | 0.60 | A |
| No. 20 | Example | spinning water | 77.0 | 1.0 | 1.0 | 2.0 | 5.7 | 13.3 | | 100 | 19.0 | 0.70 | 0.00 | 0.67 | A |
| No. 21 | Example | spinning water | 78.0 | 1.0 | 0.5 | 2.0 | 5.6 | 13.0 | | 100 | 18.5 | 0.70 | 0.00 | 0.80 | A |
| No. 22 | Example | spinning water | 78.0 | 1.0 | 2.0 | 1.0 | 1.8 | 16.2 | | 100 | 18.0 | 0.90 | 0.00 | 0.33 | A |
| No. 23 | Comparative | spinning water | 77.0 | 1.0 | | 3.0 | 9.5 | 9.5 | | 100 | 19.0 | 0.50 | 0.00 | 1.00 | — |
| | Example | | | | | | | | | | | | | | |
| No. 24 | Example | spinning water | 76.0 | 1.0 | | 3.0 | 7.6 | 11.4 | 1.0 | 100 | 19.0 | 0.60 | 0.09 | 1.00 | A |
| No. 25 | Example | spinning water | 76.5 | 1.0 | | 3.0 | 5.7 | 13.3 | 0.5 | 100 | 19.0 | 0.70 | 0.04 | 1.00 | A |
| No. 26 | Example | spinning water | 77.0 | 1.0 | | 3.0 | 5.4 | 12.6 | 1.0 | 100 | 18.0 | 0.70 | 0.08 | 1.00 | A |
| No. 27 | Example | spinning water | 76.5 | 1.0 | | 3.0 | 1.8 | 16.2 | 1.5 | 100 | 18.0 | 0.90 | 0.09 | 1.00 | A |
| No. 28 | Comparative | spinning water | 79.0 | 1.0 | 3.0 | | 5.1 | 11.9 | | 100 | 17.0 | 0.70 | 0.00 | 0.00 | — |
| | Example | | | | | | | | | | | | | | |
| No. 29 | Example | spinning water | 78.0 | 1.0 | 1.0 | 2.0 | 1.7 | 15.3 | 1.0 | 100 | 17.0 | 0.90 | 0.07 | 0.67 | A |
| No. 30 | Comparative | spinning water | 80.0 | 1.0 | 3.0 | | 1.6 | 14.4 | | 100 | 16.0 | 0.90 | 0.00 | 0.00 | — |
| | Example | | | | | | | | | | | | | | |
| No. 31 | Example | spinning water | 75.0 | 1.0 | 1.0 | 2.2 | 13.1 | 7.7 | | 100 | 20.8 | 0.37 | 0.00 | 0.69 | A |
| No. 32 | Comparative | spinning water | 77.0 | 1.0 | 3.0 | | 9.5 | 9.5 | | 100 | 19.0 | 0.50 | 0.00 | 0.00 | — |
| | Example | | | | | | | | | | | | | | |

In Tables 1 and 2, among the soft magnetic powders of the respective Sample Nos., those corresponding to the present disclosure are denoted by □Ex.□ (Example), and those not corresponding to the present disclosure are denoted by □Comp. Ex.□ (Comparative Example).

Further, when x and y in the alloy composition of the soft magnetic powder of each Sample No. are located inside any of the regions A, B, and C, □A□ is entered in the column of □Region A□, and when x and y are located outside the region A, □−□ is entered in the column of □Region A□.

### 2. Evaluation of Soft Magnetic Powder and Powder Magnetic Core

### 2.1. Evaluation of Crystalline Structure of Soft Magnetic Powder

The soft magnetic powders obtained in the respective Examples and the respective Comparative Examples were each processed into a thin piece using a focused ion beam (FIB) device, whereby test pieces were obtained.

Subsequently, the obtained test pieces were observed using a scanning transmission electron microscope (STEM).

Subsequently, the particle diameter of the crystalline structure was measured from the observation image, and the area ratio of the crystalline structure having a particle diameter within the specific range of 1.0 nm or more and 30.0 nm or less was determined, and the determined area ratio was regarded as the content of the crystalline structure having a predetermined particle diameter.

Subsequently, the area ratio of the amorphous structure was determined, and the determined area ratio was regarded as the volume ratio of the amorphous structure, and also the ratio of the content of the amorphous structure to the content of the crystalline structure having a predetermined particle diameter (amorphous/crystalline) was determined.

Further, the average crystalline particle diameter was determined together.

The evaluation results are shown in Tables 3 and 4.

### 2.2. Measurement of Coercive Force of Soft Magnetic Powder

With respect to each of the soft magnetic powders obtained in the respective Examples and the respective Comparative Examples, the coercive force was measured under the following measurement conditions.

Measurement Conditions for Coercive Force
Measurement device: vibrating sample magnetometer, VSM system, TM-VSM 1230-MHHL, manufactured by Tamakawa Co., Ltd.

Then, the measured coercive force was evaluated according to the following evaluation criteria.

Evaluation Criteria for Coercive Force

A: The coercive force is less than 0.5 Oe.

B: The coercive force is 0.5 Oe or more and less than 1.0 Oe.

C: The coercive force is 1.0 Oe or more and less than 1.33 Oe.

D: The coercive force is 1.33 Oe or more and less than 1.67 Oe.

E: The coercive force is 1.67 Oe or more and less than 2.0 Oe.

F: The coercive force is 2.0 Oe or more.

The evaluation results are shown in Tables 3 and 4.

### 2.3. Measurement of Magnetic Permeability of Powder Magnetic Core

With respect to each of the powder magnetic cores obtained in the respective Examples and the respective Comparative Examples, the magnetic permeability was measured under the following measurement conditions.

Measurement Conditions for Magnetic Permeability
Measurement device: impedance analyzer, 4194A, manufactured by Agilent Technologies, Inc.
Measurement frequency: 1 MHz
Number of turns of winding: 7
Wire diameter of winding: 0.5 mm

The measurement results are shown in Tables 3 and 4.

### 2.4. Measurement of Iron Loss of Powder Magnetic Core

With respect to each of the powder magnetic cores obtained in the respective Examples and the respective Comparative Examples, the iron loss was measured under the following measurement conditions.

Measurement Conditions for Iron Loss
Measurement device: BH analyzer, SY-8258, manufactured by Iwatsu Electric Co., Ltd.
Measurement frequency: 1 MHz
Number of turns of winding: 36 at primary side, 36 at secondary side
Wire diameter of winding: 0.5 mm
Maximum magnetic flux density: 10 mT

The measurement results are shown in Tables 3 and 4.

### 2.5. Calculation of Magnetic Flux Density of Soft Magnetic Powder

With respect to each of the soft magnetic powders obtained in the respective Examples and the respective Comparative Examples, the magnetic flux density was measured as follows.

First, the true specific gravity p of each of the soft magnetic powders was measured using a fully automatic gas displacement pycnometer, AccuPyc 1330, manufactured by Micromeritics Instrument Corporation.

Subsequently, the maximum magnetization Mm of the soft magnetic powder was measured using the vibrating sample magnetometer used in 2.2.

Subsequently, the magnetic flux density Bs was determined according to the following formula.

Bs=4π/10000×ρ×Mm

The calculation results are shown in Tables 3 and 4.

TABLE 3

| | | | Evaluation results of crystalline structure, magnetic properties, electrical properties, etc. | | | | | | | |
|---|---|---|---|---|---|---|---|---|---|---|
| | | | Content of | | | Average | | | | |
| | | | crystalline structure | Content of | | crystalline | | | | Magnetic |
| | Example/ | Structure | with predetermined | amorphous | Amorphous/ | particle | Coercive | Magnetic | Iron | flux |
| Sample | Comparative | before heat | particle diameter | structure | crystalline | diameter | force | permeability | loss | density |
| No. | Example | treatment | vol % | vol % | times | nm | — | — | kW/m³ | T |
| No. 1 | Comparative | crystalline | 0 | 0 | — | >30 | F | 23 | 20 | 1.06 |
| | Example | | | | | | | | | |
| No. 2 | Example | amorphous | 65 | 35 | 0.54 | 10.8 | A | 26 | 5 | 1.18 |
| No. 3 | Example | amorphous | 66 | 34 | 0.52 | 10.5 | A | 27 | 7 | 1.21 |
| No. 4 | Example | amorphous | 72 | 28 | 0.39 | 9.4 | A | 28 | 7 | 1.25 |
| No. 5 | Example | amorphous | 83 | 17 | 0.20 | 9.7 | A | 31 | 8 | 1.29 |
| No. 6 | Example | amorphous | 85 | 15 | 0.18 | 10.2 | A | 31 | 8 | 1.32 |
| No. 7 | Example | amorphous | 87 | 13 | 0.15 | 10.5 | A | 30 | 9 | 1.35 |
| No. 8 | Comparative | crystalline | 0 | 0 | — | >30 | F | 25 | 30 | 1.32 |
| | Example | | | | | | | | | |
| No. 9 | Example | amorphous | 86 | 14 | 0.16 | 7.5 | A | 28 | 4 | 1.39 |
| No. 10 | Example | amorphous | 69 | 31 | 0.45 | 16.8 | A | 30 | 4 | 1.43 |
| No. 11 | Example | amorphous | 89 | 11 | 0.12 | 7.5 | A | 29 | 3 | 1.46 |
| No. 12 | Example | amorphous | 53 | 47 | 0.89 | 22.3 | A | 29 | 5 | 1.44 |
| No. 13 | Comparative | crystalline | 0 | 0 | — | >30 | F | 26 | 26 | 1.40 |
| | Example | | | | | | | | | |
| No. 14 | Example | amorphous | 88 | 12 | 0.14 | 11.6 | A | 30 | 7 | 1.45 |
| No. 15 | Comparative | crystalline | 0 | 0 | — | >30 | F | 25 | 28 | 1.41 |
| | Example | | | | | | | | | |

TABLE 4

| | | | Evaluation results of crystalline structure, magnetic properties, electrical properties, etc. | | | | | | | |
|---|---|---|---|---|---|---|---|---|---|---|
| | | | Content of | | | Average | | | | |
| | | | crystalline structure | Content of | | crystalline | | | | Magnetic |
| | Example/ | Structure | with predetermined | amorphous | Amorphous/ | particle | Coercive | Magnetic | Iron | flux |
| Sample | Comparative | before heat | particle diameter | structure | crystalline | diameter | force | permeability | loss | density |
| No. | Example | treatment | vol % | vol % | times | nm | — | — | kW/m³ | T |
| No. 16 | Comparative | crystalline | 0 | 0 | — | >30 | F | 24 | 20 | 1.05 |
| | Example | | | | | | | | | |
| No. 17 | Example | amorphous | 62 | 38 | 0.61 | 10.3 | A | 27 | 5 | 1.40 |
| No. 18 | Example | amorphous | 63 | 37 | 0.59 | 10.1 | A | 28 | 7 | 1.44 |
| No. 19 | Example | amorphous | 87 | 13 | 0.15 | 9.2 | A | 29 | 6 | 1.42 |
| No. 20 | Example | amorphous | 71 | 29 | 0.41 | 9.3 | A | 32 | 7 | 1.45 |
| No. 21 | Example | amorphous | 90 | 10 | 0.11 | 9.8 | A | 32 | 7 | 1.46 |
| No. 22 | Example | amorphous | 55 | 45 | 0.82 | 10.1 | A | 31 | 8 | 1.38 |
| No. 23 | Comparative | crystalline | 0 | 0 | — | >30 | F | 25 | 30 | 1.32 |
| | Example | | | | | | | | | |
| No. 24 | Example | amorphous | 88 | 12 | 0.14 | 7.5 | A | 29 | 4 | 1.41 |
| No. 25 | Example | amorphous | 72 | 28 | 0.39 | 16.8 | A | 31 | 4 | 1.45 |
| No. 26 | Example | amorphous | 91 | 9 | 0.10 | 7.5 | A | 30 | 3 | 1.48 |
| No. 27 | Example | amorphous | 56 | 44 | 0.79 | 22.3 | A | 30 | 5 | 1.46 |
| No. 28 | Comparative | crystalline | 0 | 0 | — | >30 | F | 27 | 25 | 1.39 |
| | Example | | | | | | | | | |
| No. 29 | Example | amorphous | 89 | 11 | 0.12 | 11.6 | A | 31 | 7 | 1.46 |
| No. 30 | Comparative | crystalline | 0 | 0 | — | >30 | F | 26 | 30 | 1.40 |
| | Example | | | | | | | | | |
| No. 31 | Example | amorphous | 30 | 70 | 2.33 | 25.0 | C | 30 | 10 | 1.25 |
| No. 32 | Comparative | crystalline | 0 | 0 | — | >30 | D | 27 | 30 | 1.24 |
| | Example | | | | | | | | | |

As apparent from Tables 3 and 4, it was ascertained that by using each of the soft magnetic powders obtained in the respective Examples, a powder magnetic core having small iron loss can be produced. Further, it was confirmed that the structure of each of the soft magnetic powders before the heat treatment is amorphous, and a small crystal is formed by the heat treatment.

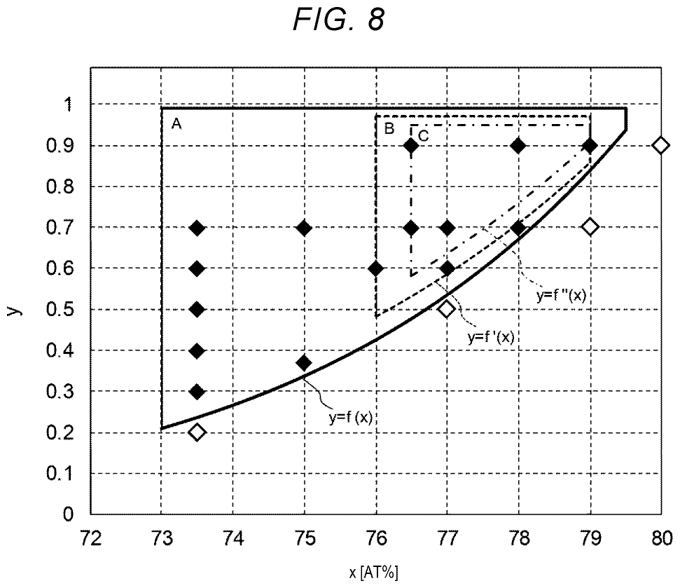

FIG. 8 is a view in which points corresponding to x and y of the alloy compositions of the soft magnetic powders obtained in the respective Examples and the respective Comparative Examples are plotted in the orthogonal coordinate system shown in FIG. 1. In FIG. 8, the points associated with the alloy compositions corresponding to Examples are indicated by black, and the points associated with the alloy compositions corresponding to Comparative Examples are indicated by white.

As shown in FIG. 8, while the respective Examples are located inside the region A surrounded by the solid line, the respective Comparative Examples are located outside the region A. Therefore, the contour of the region A can also be said to be a border whether or not a small crystal having a predetermined volume ratio is formed.

Further, it is ascertained that the powder magnetic cores containing the soft magnetic powders obtained in the respective Examples also have a high magnetic flux density.

On the other hand, in the respective Comparative Examples, the structure before the heat treatment is crystalline, and the crystalline particle diameter was not uniform.

The soft magnetic powders obtained in the respective Examples are all powders produced by a spinning water atomization method, however, also with respect to soft magnetic powders produced by a water atomization method, evaluation was performed in the same manner as described above. As a result, also the soft magnetic powders produced by the water atomization method showed the same tendency as the soft magnetic powders produced by the spinning water atomization method.

What is claimed is:

1. A soft magnetic powder, having a composition represented by
FeₓCuₐ(Nb_{1-z}Zn_{z})_{b}(Si_{1-y}B_{y})_{100-x-a-b}
wherein a, b, and x are each a number whose unit is at %, and are numbers satisfying 0.3≤a≤2.0, 2.0≤b≤4.0, and 73.0≤x≤79.5, and y is a number satisfying f(x)≤y<0.99, in which f(x)=(4×10⁻³⁴)x^{17.56}, and z is a number satisfying 0<z≤1.0, and
comprising a crystalline structure having a particle diameter of 1.0 nm or more and 30.0 nm or less at 30 vol % or more.

2. The soft magnetic powder according to claim 1, wherein z is a number satisfying 0.33≤z≤1.0.

3. The soft magnetic powder according to claim 1, further comprising an amorphous structure.

4. The soft magnetic powder according to claim 1, wherein the crystalline structure has an average particle diameter of 2.0 nm or more and 25.0 nm or less.

5. The soft magnetic powder according to claim 1, wherein a content of Al is 0.03 at % or less.

6. The soft magnetic powder according to claim 1, wherein a content of Ti is 0.02 at % or less.

7. The soft magnetic powder according to claim 1, wherein a content of C is 0.1 at % or more and 4.0 at % or less.

8. A powder magnetic core, comprising the soft magnetic powder according to claim 1.

9. A magnetic element, comprising the powder magnetic core according to claim 8.

10. An electronic device, comprising the magnetic element according to claim 9.
